(19) United States
(12) Patent Application Publication
(10) Pub. No.: US 2004/0006904 A1
(43) Pub. Date: Jan. 15, 2004

(54) Device for hanging advertising posters or showcards

(76) Inventor: Bernard Hildenbrand, Luxembourg (FR)

Correspondence Address: Gary M Cohen, Strafford Building Number Three, Suite 300, 125 Strafford Avenue, Wayne, PA, 19102, US

(21) Appl. No.: 10/398,049

(22) PCT Filed: May 7, 2001
(86) PCT No.: PCT/FR01/01377

(30) Foreign Application Priority Data
Oct. 2, 2000 (FR) 00/12478

(51) Int. Cl. G09F 7/18

(52) U.S. Cl. 40/606.01

(57) ABSTRACT

The present invention pertains to a device (1) for the suspension of signs (2) constituted by a sign (2) attachment means (3), a means for the vertical adjustment (4) of said attachment means (3) and a telescopic rod (5) enabling the ascent or descent of said attachment means (3), characterized in that the vertical adjustment means (4) is attached at a variable height in a movable manner to a beam (6) by the intermediary of two cables (7, 31) one end of each of which is attached to the adjustment means (4) and the opposite end passes over the beam (6) prior to becoming interconnected along the length of the cable by means of a spring hook (8, 36) so as to vertically immobilize said vertical adjustment means.

The present invention pertains to a suspension device for promotional notices or signs.

The invention pertains more particularly to a device that makes it possible to hang notices at various heights such as are found especially in department stores.

The positioning of such display devices is generally performed by means of a large ladder or a lift truck, which creates the risk of falling for the installer as well as a risk for the clients in the case such a sign should fall while it is being installed.

Already known in the prior art, notably from patent document FR-A-2 547 441, is a sign suspension device which can resolve the drawbacks mentioned above. This device is constituted by a horizontal bar equipped with clamps suspended by their ends from two rollers attached to the ceiling and a telescopic pole that has an S-curved end to implement the vertical ascending and descending movement of the bar.

Although devices of this type have been known and used for many years, they continue to be the object of developments intended to make them easier to handle, notably in terms of greater simplicity and improved efficiency.

The present invention thus has the objective of proposing a device for suspending signs of the type described above which is very easy to use by a single person and which also allows suspension of signs of very diverse widths.

For this purpose, the object of the present invention is a device for the suspension of signs constituted by a sign attachment means, a means for the vertical adjustment of said attachment means and a telescopic rod enabling the ascent or descent of said attachment means, characterized in that the vertical adjustment means is attached at a variable height in a movable manner to a beam by the intermediary of two cables one end of each of which is attached by means of an adjustment device and the opposite end passes over the beam prior to becoming interconnected along the length of the cable by means of a spring hook so as to vertically immobilize said vertical adjustment means.

According to a first mode of implementation, the adjustment means is constituted by two rollers interconnecting with each other by the sign attachment means, each of the rollers being constituted by a cable capable of winding and unwinding on a rotating cylinder as a function of the compression of a spiral spring and a brake. The roller brakes are associated by a single actuation control intended to synchronize the winding and unwinding of the cables of the rollers, it being possible to operate this control by means of the telescopic rod.

The following are several noteworthy attributes of the invention:

each of the brakes of each roller is constituted by a part presenting in cross section the shape of a trapezoid the large base of which is maintained in contact on the rolled-up cable on the rotating cylinder by means of a return spring;

the brake actuation control is constituted by a horizontal cable both ends of which are connected to a roller brake, said cable being maintained in tension by the return springs of the brakes;

the attachment means is constituted by a clamp formed by two horizontal bars in the interior of which are located spring plates maintained under pressure by screws of the wing nut type.

According to a second mode of implementation, the adjustment means is constituted by a cylindrical roller provided with an exterior envelope on which are fitted anchoring means intended to cooperate with one of the ends of the cable.

According to an advantageous characteristic, the adjustment means furthermore has in the interior of the exterior envelope a shaft carrying two pulleys arranged essentially at each end of the shaft, on which a cable is wound, each of the pulleys having a return spring and a reverse-lock ratchet.

According to another advantageous characteristic, the attachment means is constituted by an articulated horizontal clamp comprising a spring for maintaining the clamp in the closed position.

According to another advantageous characteristic, each of the cable ends bears a clamp anchoring system.

According to another advantageous characteristic, the clamp has essentially in its center a prehension zone for the telescopic pole.

According to a third mode of implementation, the adjustment means is constituted by two rollers connected respectively to the cables, each of the rollers being constituted by a cable capable of winding and unwinding on a rotating cylinder as a function of the compression of a spiral spring and a means for locking the unwinding of the cable.

According to another advantageous characteristic, the means for locking the unwinding of the cable for each roller is constituted by an adjustable stop, in particular made of steel, provided on the cable of the roller.

According to another advantageous characteristic, each roller is equipped with a holding means provided in a manner so as to cooperate with the stop thereby enabling the vertical maintenance in position of the sign.

According to another advantageous characteristic, the sign attachment means is constituted by a horizontal bar attached to the cables of the roller by rings.

According to another advantageous characteristic, the telescopic rod is provided at one of its ends with two horizontal pins, aligned on the same axis, capable of each engaging respectively in one of the rings so as to enable descending of the attachment means.

The characteristics of the invention mentioned above, as well as other characteristics, will become clarified upon reading the description below of an example of implementation with reference to the drawings in which:

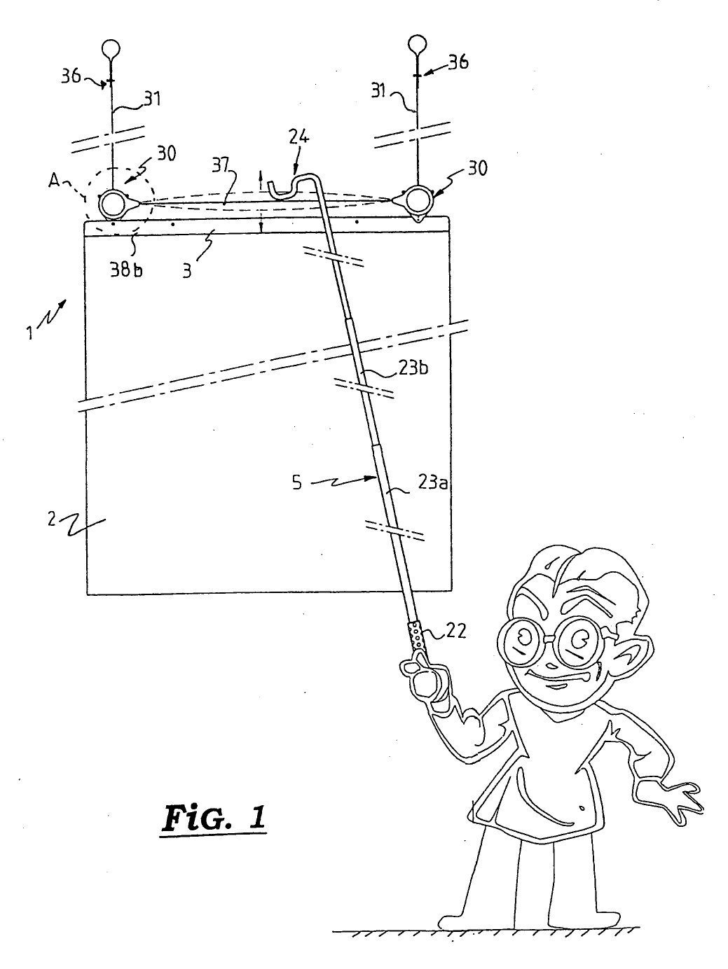

FIG. 1 is a front view of the sign suspension device according to the present invention,

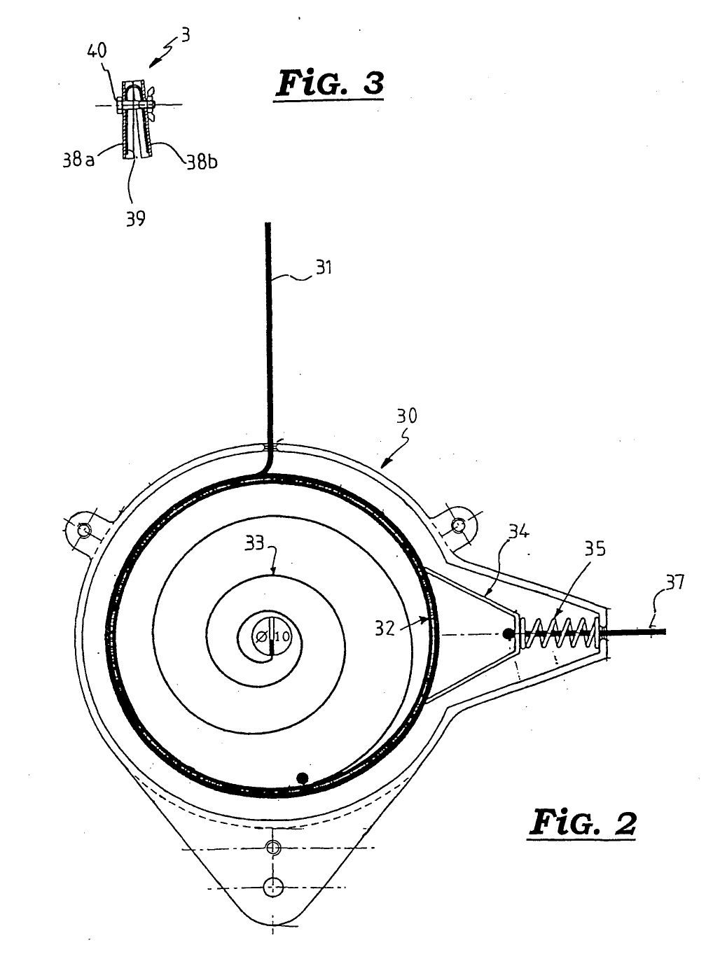

FIG. 2 is a sectional view at a larger scale of the circled part A of FIG. 1,

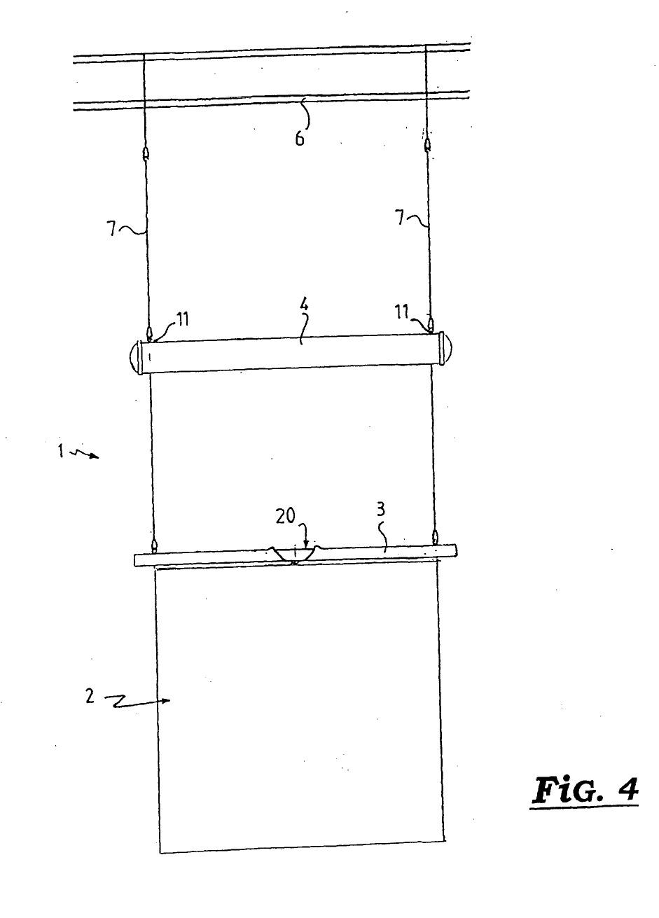

FIG. 3 is a cross sectional view of the sign attachment means,

FIG. 4 is a view similar to FIG. 1 according to a second mode of implementation,

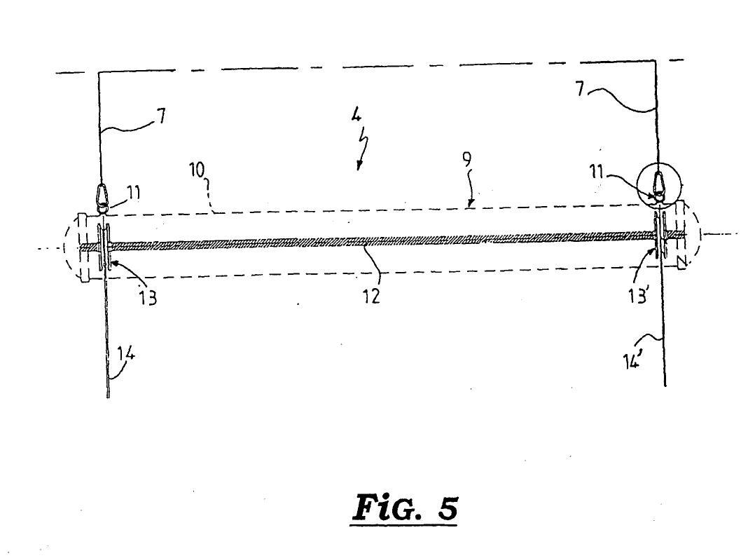

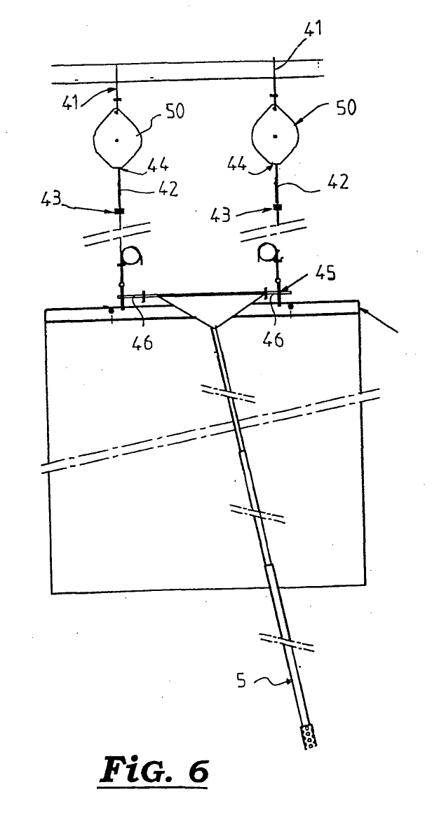

FIG. 5 is a detail view of the roller of the device according to the second mode of implementation, and,

FIG. 6 is a view similar to FIG. 1 according to a third mode of implementation.

Shown in FIG. 1 is a suspension device 1 for a sign 2, which device is constituted by a sign 2 attachment means 3, a device 4 for the vertical adjustment of said attachment means 3 and a telescopic rod 5 to cause the ascent or descent of this attachment device 3.

According to the present invention, the vertical adjustment means 4 is constituted by two rollers 30 interconnecting with each other by the sign 2 attachment means 3 and constituted respectively in a conventional manner of a cable 31 capable of winding and unwinding on a rotating cylinder 32 as a function of the tension of a spiral spring 33, i.e., its subjection to compression, and a brake 34.

Each of the brakes 34 of each roller 30 is, for example, constituted by a part presenting in cross section the shape of a trapezoid, the large base of which is maintained in contact on the cable 31 wound on the rotating cylinder 32 by means of a return spring 35.

The free end of each of the cables 31 of the rollers passes over a beam 6 of the rail or framework type prior to being interconnected over the length of the cable by means of a spring hook 36.

According to a variant the free end of each cable is attached directly to the ceiling.

The brakes 34 of the rollers 30 are advantageously associated by a single actuation control 37 intended to synchronize the winding and unwinding of the cables 31 of the rollers 30 thereby ensuring an appropriate horizontal positioning upon ascent or descent of the sign 2.

This brake 34 actuation control 37 is constituted, for example, by a horizontal cable each end of which is connected to a brake 34 of a roller 30. This cable 31 is maintained under tension by the return spring 35 of the brake 34 as can be seen in FIG. 2.

This control 37 is actuated by means of the telescopic rod 5 shown in FIG. 1.

This telescopic rod or pole 5 is constituted, for example, by aluminum tubes 23a, 23b sliding in each other, a means for locking the sliding tubes and an S-shaped hook 24 enabling all vertical ascending and descending movement of the rod.

This rod 5 is also provided with a rubber handle 22 facilitating handling for installing signs 2.

The attachment means 3 is constituted by a clamp formed by two horizontal bars 38a, 38b, made, for example of aluminum, and inside of which are arranged spring plates 39 maintained under pressure by screws of the wing nut type 40 as can be seen in FIG. 3.

The operation of the device can already be understood from the description above; it will be explained in greater detail below.

Once the sign has been attached and hung on the beam 6, it can very easily be moved along said beam.

The user remains standing on the floor and uses the telescopic pole or rod 5 to release the horizontal cable 37 by pushing or pulling on said cable thereby releasing the brake 34 of each roller 30 which leads to the winding or unwinding of each of the cables 31 of the rollers 30 and thus the ascent or descent of the sign 2.

When the user terminates his traction on the cable 31, the brake 34 is released from each roller 30, thereby stopping the winding of the cable at the desired height, with the vertical position being maintained in a stable manner by means of said brake.

When the user wants to change the sign 2, he brings down the sign as described above, unscrews the wing nuts 40 thereby opening the clamp 3 so that he can remove the sign 2 and possibly replace it with another sign 2 before again screwing on the wing nuts 40.

According to a second mode of implementation shown in FIGS. 4 and 5, the vertical adjustment means 4 is attached at a variable height in a movable manner on a beam of the framework or reinforcement rail type by the intermediary of a cable 7, one end of which is attached to the adjustment means 4 and the opposite end of which passes over the beam 6 before becoming interconnected along the length of the cable 7 by means of a spring hook 8.

According to a preferred means of implementation, the vertical adjustment means 4 is attached to the beam 6 by two cables 7 positioned on either side of said means 4.

This adjustment means 4 is advantageously constituted by a cylindrical roller 9 provided with an exterior envelope 10 on which are fitted anchoring means of the ring type 11 intended to cooperate with one of the ends of each of the cables 7 as can be seen in FIG. 5.

This roller has inside the exterior envelope 10 a shaft 12 carrying two pulleys arranged essentially at each end of the shaft 12 on which is wound a cable respectively designated by the general reference 14, 14′. Each of the pulleys 13, 13′ has in a known manner a return spring and a reverse-lock ratchet, not shown.

Each of the ends of the cables 14, 14′ has an anchoring system to the attachment means 3 of the sign 2 of the spring hook type as can be seen in FIG. 1.

The attachment means 3 is moreover constituted by an articulated horizontal clamp of variable length as a function of the sign and comprising a closed position-maintenance spring of the clamp.

Moreover, in order to facilitate the handling of the signs, the horizontal clamp 3 has essentially in its center a prehension zone for the telescopic rod 5.

The operation of this second mode of implementation can already be understood from the description above; it will be explained below.

Once the device has been attached and hung on the beam, it can very easily be moved along the length of said beam. The user moreover adjusts in advance the length of its suspension as a function of the height of the store by the intermediary of the cables 7.

Standing on the floor and using the telescopic pole, the user pulls on the clamp thereby causing the horizontal descent of said clamp. The clamp is either removed to be replaced by a clamp of suitable size for the sign or left in place and opened in order to immobilize the sign on said clamp.

Using the telescopic pole, the user then remounts the clamp which winds each cable on its respective pulley and then stops this winding at the desired height, the vertical position being maintained in a stable manner by means of the reverse-lock ratchets.

According to a third mode of implementation shown in FIG. 6, the vertical adjustment means 4 is constituted by two rollers 50 connected in a movable manner to a beam by the intermediary of a cable in a manner similar to the second mode of implementation. Each of the rollers 50 is constituted by a cable 42 that can wind and unwind on a rotating cylinder as a function of the compression of a spiral spring and a cable 42 winding locking means 43.

The cable 42 winding locking means 43 for each roller is constituted by an adjustable stop, in particular made of steel, provided on the cable 42 of the roller 50.

Each roller 50 is moreover provided with a holding means of the magnetic type 44 provided in a manner so as to cooperate with the stop 43 thereby enabling the vertical maintenance of the sign by magnetization of said stop.

According to this third mode of implementation, the sign attachment means is constituted by a horizontal bar attached to the cables 42 of the rollers by rings 45.

The telescopic rod is advantageously provided at one of its ends with two horizontal pins 46 aligned on the same axis and each capable of engaging respectively in one of the rings 45 so as to enable the descent of the attachment means.

Reading of the above description will allow comprehension that the device of the present invention is relatively simple to implement and makes it possible to keep the sign in a correct horizontal position when the sign is raised up in relation to the prior solution by means of the synchronization of the winding of the two pulleys.

This device can moreover be completely disassembled which provides the advantage that it can be transferred to another site without any cost.

Although the invention has been described with reference to three particular modes of implementation, it extends to all technical equivalents of the means described.

1. Device (1) for the suspension of signs (2) constituted by a sign (2) attachment means (3), a means for the vertical adjustment (4) of said attachment means (3) and a telescopic rod (5) enabling the ascent or descent of said attachment means (3), characterized in that the vertical adjustment means (4) is attached at a variable height in a movable manner to a beam (6) by the intermediary of two cables (7, 31) one end of each of which is attached to the adjustment means (4) and the opposite end passes over the beam (6) prior to becoming interconnected along the length of the cable by means of a spring hook (8, 36) so as to vertically immobilize said vertical adjustment means.

2. Suspension device according to claim 1, characterized in that the adjustment means (4) is constituted by two rollers (30) interconnecting with each other by the sign (2) attachment means (3), each of the rollers (30) being constituted by a cable (31) capable of winding and unwinding on a rotating cylinder (32) as a function of the compression of a spiral spring (33) and a brake (34), and in that the brakes (34) of the rollers (30) are associated by a single actuation control (37) intended to synchronize the winding and unwinding of the cables (31) of the roller (30), it being possible to operate this control by means of the telescopic rod (5).

3. Device according to claim 2, characterized in that each of the brakes (34) of each roller (30) is constituted by a part presenting in cross section the shape of a trapezoid the large base of which is maintained in contact on the cable (31) wound on the rotating cylinder (32) by means of a return spring (35).

4. Device according to claim 2 or 3, characterized in that the brake (34) actuation control (37) is constituted by a horizontal cable each end of which is connected to a brake of a roller, said cable being maintained in tension by the return springs (35) of the brakes (34).

5. Device according to any one of the preceding claims, characterized in that the attachment means (3) is constituted by a clamp formed by two horizontal bars (38a, 38b) inside of which are positioned spring plates (39) maintained under pressure by screws of the wing nut type (40).

6. Suspension device according to claim 1, characterized in that the adjustment means (4) is constituted by a cylindrical roller (9) provided with an exterior envelope (10) on which are fitted anchoring means (11) intended to cooperate with one of the ends of the cable (7).

7. Suspension device according to claim 6, characterized in that the adjustment means (4) moreover has inside the exterior envelope (10) a shaft (12) carrying two pulleys (13 and 13′) arranged essentially at each end of the shaft (12) on which is wound a cable (14 and 14′), each of the pulleys (13, 13′) comprising a return spring and a reverse-lock ratchet.

8. Suspension device according to claim 6 or 7, characterized in that the attachment means (3) is constituted by an articulated horizontal clamp comprising a spring for holding the clamp in the closed position.

9. Suspension device according to claims 7 and 8 taken together, characterized in that each of the ends of the cables (14, 14′) has a clamp anchoring system (3).

10. Device according to claim 8 or 9, characterized in that the clamp (3) has essentially in its middle a prehension zone (20) for the telescopic rod (5).

11. Device according to claim 1, characterized in that the adjustment means (4) is constituted by two rollers (50) connected respectively to the cables (41), each of the rollers (50) being constituted by a cable (42) capable of winding and unwinding on a rotating cylinder as a function of the compression of a spiral spring and a locking means (43) of the winding of the cable (42).

12. Device according to claim 11, characterized in that the cable winding (42) locking means (43) for each roller is constituted by an adjustable stop, in particular made of steel and fitted on the cable of the roller.

13. Device according to claim 12, characterized in that each roller (50) is provided with a holding means (44) fitted so as to cooperate with the stop (43) thereby enabling the vertical holding of the sign (2).

14. Device according to one of claims 11 to 13, characterized in that the sign holding means (3) is constituted by a horizontal bar attached to the cables (42) of the rollers (50) by rings (45).

15. Device according to claim 14, characterized in that the telescopic rod (5) is fitted at one of its ends with two horizontal pins (46) aligned on the same axis and capable of each engaging respectively in one of the rings (45) so as to enable the descent of the attachment means (3).
